(19) United States
(12) Patent Application Publication
(10) Pub. No.: US 2022/0142759 A1
(43) Pub. Date: May 12, 2022

(54) UPPER JAW FITTING ELEMENT FOR FITTING TO A HUMAN UPPER JAW

(71) Applicant: Jörg SCHLIEPER, Henstedt-Ulzburg (DE)

(72) Inventor: Jörg SCHLIEPER, Henstedt-Ulzburg (DE)

(21) Appl. No.: 17/438,911

(22) PCT Filed: Mar. 9, 2020
(86) PCT No.: PCT/EP2020/056137

§ 371 Date: Sep. 13, 2021

(30) Foreign Application Priority Data
Mar. 13, 2019 (DE) 10 2019 106 403.1
Aug. 30, 2019 (DE) 10 2019 123 370.4

(51) Int. Cl. A61C 19/045; A61C 19/05; A61C 9/00

(52) U.S. Cl. CPC A61C 19/045; A61C 9/0053; A61C 19/05

(57) ABSTRACT

The invention relates to an upper jaw contact element for contact with a human upper jaw, which contact element is formed as a dental arch-shaped upper jaw bite fork (5) which has receiving portions on at least the open end portions that are configured to reversibly receive upper jaw crowns, in particular with the aid of impression material, in a manner as to be stable during manipulation, and which can be connected to at least one jaw relation element (6, 7, 8, 500) in the area of vertex of the arch.

### BACKGROUND OF THE INVENTION

### Field of the Invention

One or more embodiments of the invention relate to the field of dentistry devices.

### Description of the Related Art

The present invention relates to an upper jaw fitting element for fitting to a human upper jaw.

Upper jaw fitting elements are well known and widely used in the field of dentistry. One purpose of application of upper jaw fitting elements is to measure the upper jaw and/or to seta jaw relation position of the upper and the lower jaw in relation to each other and/or to provide jaw relation data.

The provision of jaw relation data, i.e., a spatial relation of both jaws to each other and thus the spatial relation of the individual tooth crowns of both jaws to each other, is essential for manufacturing splints in the field of dentistry and oral and maxillofacial surgery, for manufacturing dental prostheses in the field of prosthetics, jaw adjustments in the field of orthodontics, splints for the temporomandibular joint in the field of functional therapy and mandibular advancement splints in the field of dental sleep medicine.

For detecting the jaw relation data, a distinction is made between a static and a dynamic jaw relation: The static jaw relation is the representation of a static situation by means of static three-dimensional position data, i.e., the representation of a relation of the position of the lower jaw to the upper jaw. The dynamic jaw relation is the representation of a dynamic sequence of situations by means of dynamic three-dimensional position data, i.e., the representation of a plurality of relations of the position of the lower jaw to the upper jaw within one motion sequence.

Both the static and the dynamic jaw relation can be identified or registered on the subject by means of devices using passive or active and analog or digital methods. In case of passive methods, the examiner, e.g., the physician, predetermines the position and/or the movement of the lower jaw of the human subject, e.g., by manual and/or instrumental and/or mechanical guidance. This means that the subject does not assume or perform the static or dynamic jaw relation themselves. In contrast, in the active method, the subject performs these movements themselves, if applicable, according to the instructions of the examiner, or assumes the jaw relation position themselves, respectively. There are also combined forms in which, for example, the subject themselves, i.e., actively, assumes a static jaw relation and is passively kept in this position, or the subject actively performs a sequence of situations but under guidance, or the subject is passive and is actively supported during movement, or vice versa.

The analog and digital methods can be further differentiated between analog and digital methods for static jaw relation and analog and digital methods for dynamic jaw relation. An analog method for static jaw relation uses an impression with impression materials or analog measuring systems. An analog method for dynamic jaw relation uses a plurality of impressions with impression materials or analog measuring systems. A digital method of static or dynamic jaw relation uses digital measuring systems, such as ultrasound, high frequency, or light scanners, in particular so-called intraoral scanners, etc. It is also possible to combine analog and digital as well as passive and active methods. In each case, the respective devices need to be adapted to the respective method.

The devices usually serve to optimize only one or several of these methods and to utilize the analog and/or digital methods in the procedure. In such procedures the devices used are usually bite forks.

Two bite forks, which support a limited active, static and exclusively analog method for determining the jaw relation, are known from DE 103 31 531 A1 and DE 42 92 389 B4. A combined active/passive method is only possible with respect to lower jaw protrusion, i.e., lower jaw advancement, or anterior-posterior jaw relation, wherein the subject performs an active protrusion movement of their lower jaw into a specific desired jaw relation, in which they are then kept quasi passively by means of the bite fork. It is not possible to set a variable bite lock, which is characterized by a vertical distance between the upper and the lower teeth, i.e., a cranio-caudal jaw relation. This is disadvantageous because for a desired jaw lock (i.e., a vertical jaw relation or the vertical distance), the bite fork must be manually reworked on the patient. This takes time and is also uncomfortable for the subject because it requires work in the subject's mouth. If the modification does not meet the requirements after it is completed and was checked within the mouth, a remodification (including the above-mentioned disadvantages) is required.

Another disadvantage results from the exclusively analog registration of the jaw relation by means of impression material if the bite lock no longer allows for a simultaneous intraoral scan of the upper and the lower teeth. Furthermore, these bite forks are not suitable for a secure method for active registration, as no secure fixation of the upper teeth in relation to the lower teeth is achieved. This is due to the fact that the devices tend to tilt, since they are, with impression material in between, only positioned between the occlusal surfaces, i.e., the chewing surfaces, of the upper and lower teeth, i.e., they do not cover the entire tooth crowns, with impression material in between, for better retention. In particular, the bite fork disclosed in DE 42 92 389 B4 has a larger bite lock for positioning the jaw relation because it uses two superimposed elements. In DE 103 31 531 A1, a guiding element is provided on the internal side to allow for a reduced bite lock, however, this guiding element often does not withstand the bite force when used.

From DE 10 2014 102 770 A1, a device is known that supports an active, dynamic and digital method for registering the jaw relation, but not a passive, static or dynamic method (fixation or guidance of the lower jaw in a particular position or in a particular movement towards the upper jaw). This is disadvantageous because a lower jaw position assumed by the subject may change during the time of registration of the jaw relation (active method). The lack of fixation or support of the lower jaw position with respect to the upper jaw regularly leads to deviations caused by random or unintentional movement of the subject's lower jaw, which makes an analog registration, e.g., with impression material, impossible.

Thus, the registration of the jaw relation using this device is only possible with the digital method. A further disadvantage is that the spatial position of the bite fork cannot be registered directly in the subject's mouth, and is thus the position of the registration device in relation to the upper jaw. The registration device is attached to an upper jaw bite fork, the spatial position of which in relation to the teeth must be determined. The upper jaw bite fork rests, with impression material in between, on the upper jaw tooth crowns.

To determine the spatial position of the bite fork in relation to the teeth, the bite fork must be removed from the subject's mouth and the entire impression-side portion of the bite fork including the positioning marker elements of the bite fork must be detected by scanner optics for superimposition with the scan of the tooth crowns. With this analog step of transferring the analog information of the upper tooth impression into digital data for superimposition with the digital data of the scan of the upper jaw tooth crowns, this system leaves the exclusively digital workflow, which is hereinafter also referred to as fully digital workflow, leading to errors which can later cause inaccuracies during the registration of the jaw relation. Furthermore, the upper jaw bite fork must be fixed to or on the tooth crowns such that it can be easily detached from the tooth crowns for determining the spatial position. This often results in insufficient static friction, which is required to prevent the upper jaw bite fork from slipping while it is positioned on the jaw.

DE 10 2010 021 934 A1 discloses a registration system for active, dynamic and digital detection of the jaw relation. A measuring unit positioned in the midface is adjusted in relation to the skull via a paraocclusal upper jaw bite fork with a measuring unit using electronic sensors, so that the jaw relation can be successfully registered with the measuring unit in the midface in relation to the skull after moving the measuring unit from the upper jaw paraocclusal bite fork to the lower jaw paraocclusal bite fork. The disadvantages here are that there is no possibility for an active, static and analog method for registering the jaw relation and that a third measuring unit in the midface is required.

The paraocclusal bite forks used in DE 10 2010 021 934 A1 are widely used and known in the field of dentistry. In principle, such bite forks are manufactured on individual jaw models in the dental laboratory and are time-consuming and costly. Paraocclusal bite forks that are easier to manufacture and thus save time and money are mechanically less resilient than laboratory-fabricated paraocclusal bite forks. In addition, the paraocclusal bite fork is formed such that it completely covers or surrounds the tooth crowns when inserted. This creates an uncomfortable sensation for the patient, in particular in the molar area of the upper jaw, and may even cause a gag reflex, which must then be suppressed during the entire process of detecting the jaw relation.

Intraoral scanners are increasingly common in dental practice. An intraoral scanner is, for example, known from DE 196 40 495 C2. Such scanners work with the photo-optical principle, wherein three-dimensional objects or motion sequences can be detected via repetitive photos from different perspectives, which are combined to form an overall spatial image.

Intraoral scanners are known which allow for both a static and a dynamic analog method for registering the jaw relation, which they make accessible for CAD/CAM technology via a predetermined file format, e.g., STL format. For registration, the scanner optics are laterally directed to the upper and lower jaw tooth rows, while the lower jaw performs movements (active and/or passive, digital, dynamic method). Due to the dimensions of the apparatus for intraoral use, the detection range of the scanner optics is limited to slightly more than one tooth crown width. This only allows for a registration of jaw relations in a very small range, in which the scanner optics can still detect sufficient upper and lower jaw tooth crown portions for registration, between the jaw relation in the final down bite, i.e., with maximum contact between the upper and the lower teeth, and the jaw relation with bite lock.

The intraoral scanner is currently the method of choice for registering the dental arch, i.e., all the crowns in a jaw. With this method, the examiner moves the detection range of the scanner over all of the subject's tooth crown surfaces and combines the individual scans, i.e. (digital) images or photos, to form a three-dimensional overall image—the image of the upper jaw or lower jaw dental arch, including the gingival and adjacent oral mucosa portions, if applicable.

For the registration of the dental arch, the intraoral scanner needs some exposed tooth crowns, in order to be able to determine, depending on their position in the jaw, the position of the other tooth crowns. Setting a jaw relation position requires the fitting element to adhere firmly enough to the tooth crowns to not slip due to forces occurring in the jaw relation position.

### BRIEF SUMMARY OF THE INVENTION

The object of the invention is to provide an upper jaw fitting element for fitting to a human upper jaw, which allows for secure retention on the upper jaw during the setting of a jaw relation position, and/or a jaw relation movement into a jaw relation position, and/or during the registration or detection of the jaw relation position, e.g. by means of an intraoral scanner, and which can be inserted in a manner that is comfortable for the patient.

The invention achieves the object by designing a generic upper jaw fitting element such that the upper jaw fitting element is adapted as a dental arch-shaped upper jaw bite fork which comprises, at least at the open end sections, receiving areas configured to reversibly receive, in particular with the aid of impression material, upper jaw tooth crowns in a manner as to be stable during manipulation, and which can be connected to least one jaw relation element in the area of a vertex of the arch.

In particular, a plurality of jaw relation elements is provided for setting a jaw relation position and/or for detecting jaw relation data. These can be connected either directly to the upper jaw bite fork or connected indirectly to the upper jaw bite fork via other jaw relation elements.

The advantage of such an upper jaw fitting element is that it is suitable for all above-mentioned methods for detecting jaw relation data, e.g., jaw relation movements, jaw relation positions, in particular by means of an intraoral scanner, while ensuring a secure, tilt- and shake-free fit for applications in the entire jaw relation spectrum, i.e., the registration of all possible jaw relations.

At the same time, the upper jaw fitting element leaves out as many tooth crowns and/or as much gingiva and/or oral mucosa, which collectively may also be referred to as anatomical structures of the upper jaw, as possible, at least to the extent that their positions can be detected by a scanner. In addition, the upper jaw fitting element is configured such that the patient perceives both the insertion thereof, with or without jaw relation elements attached thereto, and the setting of the jaw relation elements to create a desired jaw relation position, or the setting of the jaw relation position, respectively, as comfortable.

Advantageous embodiments and further developments of the upper jaw fitting element are described in the dependent claims and explained below.

One advantageous embodiment provides that the receiving areas leave out an area of the anterior tooth crowns and/or anterior tooth crown portions and/or gingiva and/or at least partially the vestibule with the oral mucosa delimiting the vestibule. Additionally or alternatively, the receiving areas may leave out tooth crowns and/or tooth crown portions and/or gingiva and/or at least partially the vestibule located distally to the area of the anterior tooth crowns. This means that the cut-outs are also made, exclusively or additionally, on further or other tooth crowns and/or tooth crown portions and/or gingival portions and/or vestibular portions than the anterior tooth crowns, and that the cut-outs are continued until, finally, only (partial) circumferences of all or part of the tooth crowns of the upper jaw dental arch, with or without adjacent gingiva and/or vestibule, are covered. The principle for the detection of jaw relation data by means of, for example, a scanner, in particular an intraoral scanner, is that the more tooth crowns or tooth crown portions are visible, the better, since the detection accuracy improves with an increasing number of visible tooth crowns, or at least tooth crown portions.

In contrast to known paraocclusal bite forks, which rest against the dental arch on the outer side of its tooth crowns and against the areas between the tooth crowns, the interdental area, at their largest circumference by means of clamping fit, the upper jaw fitting element according to the invention, i.e. the upper jaw bite fork according to the invention, rests, with impression material in between, completely or at least partially, on and/or against and/or close to the tooth crowns and/or the gingiva and/or at least parts of the vestibule.

In particular, the upper jaw bite fork according to the invention can be inserted ready-made. The upper jaw bite fork can thus already be fixed to the upper jaw, with impression material in between, during the first appointment with the subject, whereas the known, individual, not-ready-made paraocclusal bite forks, which have to be manufactured in the laboratory, are manufactured in the laboratory after taking an impression of the upper teeth during a first appointment with the subject and can only in a second session be fixed to the upper jaw. Furthermore, with the upper jaw bite fork, the three-dimensional surfaces can be known and do not have to be gathered again for each application. Compared to known bite forks, which are available ready-made in various dental arch sizes common in dentistry, the upper jaw bite fork according to the invention can be used universally, irrespective of the size of a patient's upper jaw. This means that the upper jaw bite fork according to the invention can be used universally in only one size for all sizes of lower jaws and thus does not need to be in stock in different sizes.

Leaving out upper jaw tooth crowns or upper jaw tooth crown portions can make it easier for the examiner to position the lower jaw, i.e., to adjust the lower jaw in relation to the upper jaw in a particular relation to each other, as they can use the incisal edges or occlusal edges and, if applicable, the tooth crown portions adjacent thereto, that are left out by the upper jaw bite fork and the impression material, for orientation, which is particularly advantageous for passive methods. Moreover, these cut-outs, in particular those of a part of the posterior teeth (premolars and molars), allow to control the so-called bite lock under vision and to set it according to medical procedures.

When registering the jaw relation, in particular by means of optical or ultrasonic scanning, e.g., by a commercially available optical intraoral scanner, the cut-outs allow for the positioning of the upper jaw bite fork in relation to the upper jaw tooth crowns to be carried out via the optical scan on the basis of the exposed tooth crown portions. The detection by an optical scanner is enhanced by the cut-outs, in particular in the anterior tooth area and the rearmost posterior tooth area (molars), because the angular reference between the bite fork, on the one hand, and the dental arch, on the other hand, which can vary from patient to patient, becomes more precise due to the maximum distance between the measuring points.

Furthermore, leaving out the longest crowns in the dental arch, namely the anterior tooth crowns, also referred to as incisor tooth crowns, and, if applicable, also the canine tooth crowns, is particularly advantageous because the bite, i.e., the biting down, is locked to a lesser extent, i.e., the distance between the upper jaw tooth crowns and the lower jaw tooth crowns can be smaller than it would be without leaving out these teeth. This allows to position the lower jaw with a smaller occlusal distance between the upper and lower teeth, which may also be referred to as interocclusal distance or bite lock, than would be possible if these tooth crowns were completely covered, as in the case of impression trays, for example.

This is because the incisal edges of the anterior teeth and, if applicable, the canine teeth generally project beyond the occlusal plane of the remaining teeth. The reduced bite lock allows for the use of the upper jaw fitting element, i.e., the upper jaw bite fork, for active and passive, static and dynamic jaw relation registration or for relation registration of the tooth crowns of both jaws in relation to each other for manufacturing splints and occlusal appliances which, when inserted into the mouth of the subject or patient, have a greater than or the same bite lock as the inserted upper jaw bite fork. This is because splints and occlusal appliances rest on at least all tooth crowns in a jaw, in case of mandibular advancement devices or splints (UPS) also on at least all lower jaw tooth crowns and additionally partially on all upper jaw tooth crowns, wherein the bite lock is greater than or equal to that of the upper jaw fitting element used as the upper jaw bite fork. The difference or equality, respectively, of these two bite locks makes it possible to position a jaw relation element between the two incisal edges of the upper and lower incisors such that it can rest on the incisal edges of the lower incisor tooth crowns. Splints, occlusal appliances and/or UPS are hereinafter referred to as aids.

In one exemplary embodiment of the upper jaw fitting element, the receiving areas may have a portion that is arranged palatally adjacent and/or close to or spaced apart from the tooth crowns. This portion of the receiving areas arranged palatally to the tooth crowns stabilizes the position of the upper jaw fitting element in the transverse direction, i.e. in a left-right direction, thus preventing the upper jaw bite fork from slipping, which might be caused by forces acting transversely to the posterior teeth when setting the jaw relation position, e.g., caused by a lateral movement of the lower jaw to the right or the left with respect to the upper jaw. This makes it possible to safely guide such lateral movement of the lower jaw supported by the upper jaw bite fork.

Possible further developments of the upper jaw fitting element provide that the upper jaw bite fork is, at least in the area of the anterior tooth crowns, formed in such a manner that the gingiva, at least partially the vestibule and at least partially the labial tooth crown surfaces are covered. This creates the largest possible contact surface between the upper jaw bite fork and the upper jaw, which, with impression material in between, provides a sufficiently strong adhesion to prevent the upper jaw bite fork from slipping and/or tilting. At the same time, the incisal edges of the anterior tooth crowns remain free so that the bite lock is not increased.

In possible embodiments, the upper jaw bite fork may have at least one opening, in particular a plurality of openings, for filling a gap or intermediate space in the area of the anterior tooth crowns and/or a gap or intermediate space distal to the anterior tooth crowns between the upper jaw bite fork and the upper jaw. After aligning or positioning the upper jaw bite fork on the upper jaw dental arch, impression material is filled through the opening(s) into an intermediate space formed between the labial tooth crown surfaces and the side of the upper jaw bite fork facing the labial tooth crown surfaces, in particular until this space is completely filled with impression material.

Filling this space subsequently, i.e. after positioning the upper jaw bite fork on the upper jaw in the mouth, with impression material in between that is provided in the receiving areas between the upper tooth row and the lower tooth row, facilitates the correct positioning and adhesion of the upper jaw bite fork to the upper jaw dental arch because, on the one hand, there is no time pressure caused by impression material already being applied and beginning to harden, and on the other hand, the upper jaw bite fork can easily be inserted relatively close to the upper jaw and can no longer be moved on the upper jaw in the mouth after biting down, so that after the impression material was filled in, it can harden exactly in this correct set position of the upper jaw bite fork on the upper jaw. In addition, the fact that the intermediate space is filled subsequently allows for the intermediate space to be filled with the optimum amount of impression material so that the impression material completely fills the intermediate space, even in the interdental spaces, i.e., the spaces between the teeth, and/or other void spaces that are otherwise difficult to access, thereby achieving the greatest friction possible for the size of the intermediate space.

The openings used for filling can be round, oval, slit-shaped, star-shaped, triangular or have other shapes, and are formed in the arch-shaped area of the upper jaw bite fork, in particular in the area of the anterior tooth crowns and/or in the area of the canine tooth crowns and/or in the area of the posterior tooth crowns, in particular in the area of the premolars. A particularly advantageous embodiment provides that two openings are provided in the area of the anterior tooth crowns, each arranged on one side of a jaw relation element, which can be attached in the area of the anterior vertex of the arch.

In one exemplary embodiment, the upper jaw bite fork and the at least one jaw relation element are integrally formed. An integral design with the at least one jaw relation element being directly connected to the upper jaw bite fork increases the stability of the connection to the upper jaw bite fork. A reversible, i.e. detachable connection between the upper jaw bite fork and the at least one jaw relation element makes it possible to connect different jaw relation elements, e.g., differently sized or differently shaped jaw relation elements, to the upper jaw bite fork and thus to adapt the jaw relation elements, e.g., individually to the patient or to the examination purpose, such as e.g., setting a jaw relation position or detecting jaw relation data, without having to exchange the upper jaw bite fork. It is also possible to use the same jaw relation elements with different upper jaw bite forks, or also other bite forks, such as lower jaw bite forks. Such a reversible connection may be implemented, for example, by means of a positive fit, e.g., according to the plug-and-socket principle and a clamping fit, a clip connection, a clamp connection with a locking screw, etc.

Possible further developments of the upper jaw fitting element provide that the at least one jaw relation element is a means for setting a jaw relation, such as a particular jaw relation position, and/or a patient's jaw relation movement. Additionally or alternatively, the at least one jaw relation element may be a means for detecting a jaw relation, such as a particular jaw relation position, and/or a patient's jaw relation movement. For example, the means for setting a jaw relation may be formed of a plurality of jaw relation elements that are relatively movably and/or rotatably connected to each other to effect a jaw relation position. The means for detecting a jaw relation is, for example, a registration unit, such as an optical registration unit, e.g., a scanner or a laser, or an ultrasound or radio frequency-based registration unit. It is also possible to attach a means for detecting a jaw relation to the upper jaw bite fork via a means for setting a jaw relation position.

In one possible embodiment of the upper jaw fitting element, the open end sections of the upper jaw bite fork and the receiving areas are formed distally flush with each other. In an alternative embodiment, the open end sections of the upper jaw bite fork and the receiving areas are not formed distally flush with each other. A distally flush design of the open end sections of the upper jaw bite fork and the receiving areas provides very good stability, since in particular, the posterior tooth crowns are labially or buccally and palatally equally surrounded by the receiving areas, thus allowing for a very uniform force and/or pressure distribution by laterally acting transverse forces. If the open end sections of the upper jaw bite fork and the receiving areas are not designed distally flush, the receiving areas usually protrude or project distally beyond the open end sections. With such a design, the upper jaw bite fork portions can at least partially expose the labial or buccal tooth crown surfaces and/or gingival and/or vestibular surfaces, so they can be detected by the means for detecting jaw relation data. At the same time, the transversely acting forces are absorbed by palatally arranged portions extending distally further rearward, thus preventing the upper jaw bite fork from slipping. In addition, the patient can perceive the labially or buccally shortened upper jaw bite fork as very comfortable, since the space available for inserting an upper jaw bite fork, in particular labially to the upper jaw dental arch, decreases from the anterior tooth area towards the rear posterior tooth area. As a result of the shortening, the upper jaw bite fork no longer protrudes all the way back into the oral cavity, which in particular prevents the patient from gagging.

Additionally, or alternatively, in one possible embodiment of the upper jaw fitting element, the upper jaw bite fork can, in the area of the anterior tooth crowns, be formed wider in the cranial-caudal direction than at the open end sections and taper along the cranially located upper side. Such tapering, in particular in the upper, i.e., cranial, area of the upper jaw bite fork, also takes into account the fact that the space labial to the tooth crowns gradually decreases in the dorsal direction. The tapering adapts the upper jaw bite fork to this “lack of space” and is perceived as particularly comfortable by the patient.

One possible embodiment of the upper jaw fitting element provides that the upper jaw bite fork comprises at least one cut-out for receiving the at least one jaw relation element. The at least one jaw relation element can be inserted into this cut-out, for example, by means of a clamping fit. Alternatively, the jaw relation element can also be fixed or clamped in position therein by means of a locking screw. Alternatively, as already described above, an integral design of the upper jaw bite fork and the at least one jaw relation element or a clip connection is also conceivable.

In one possible embodiment of the upper jaw fitting element, the upper jaw bite fork may have at least one spacer, in particular an interdental pin, arranged on the surface facing the tooth crowns and adapted to align the upper jaw bite fork such as to form, between the anterior tooth crowns and/or the gingiva and/or at least partial areas of the vestibule of the upper jaw and the upper jaw bite fork, at least the intermediate space between the anterior tooth areas and, if applicable, the canine tooth areas and the upper jaw bite fork, and optionally also the intermediate space between the posterior tooth areas and the upper jaw bite fork. The at least one spacer is preferably provided in the area of the anterior vertex of the arch and is arranged on and/or in the interdental space of the two central incisors for positioning the upper jaw bite fork in relation to the upper jaw. The spacer serves to align or position the upper jaw bite fork in relation to the upper jaw tooth crowns and at the same time ensures that there is an intermediate space at least between the anterior tooth crowns and the upper jaw bite fork, which intermediate space can be used to fix the upper jaw bite fork to the upper jaw tooth crowns with an impression material, for example, comprising A-silicones, whereby a sufficiently high friction is achieved between the upper jaw tooth crowns and the upper jaw bite fork, more precisely, between the upper jaw with its tooth crowns, gingiva and vestibule and the hardened impression material as well as between the hardened impression material and the upper jaw bite fork, which reliably prevents the upper jaw bite fork from tilting and/or slipping in relation to the upper jaw tooth crowns. Designs in which the spacer is arranged peripherally, e.g., in the area of a canine tooth, or several spacers are arranged along the arch of the upper jaw bite fork, are also conceivable.

Possible further developments of the upper jaw fitting element provide that the at least one jaw relation element is arranged buccally on both sides, preferably on a lateral vertex, of the upper jaw bite fork. Jaw relation elements arranged buccally on the upper jaw bite fork are particularly advantageous for detecting the jaw relation position by the means, for example the registration unit, such as a scanner, and extend from the upper jaw bite fork to a point at least close to the incisal and/or occlusal planes of the lower jaw tooth crowns, so that both the jaw relation element and anatomical structures of the lower jaw can be detected. Often, the means cannot detect both the upper jaw and the lower jaw together at the same time. Therefore, the upper jaw and the lower jaw, either in one continuous detection operation one after the other, or in two separate detection operations, are detected separately from each other, wherein the means detects the buccal jaw relation elements both together with the upper jaw and together with the lower jaw. With the position of the buccal jaw relation elements, the allocation of the upper jaw position to the lower jaw position can now be performed in a superimposition operation, whereby the jaw relation position can be correctly determined.

In one exemplary embodiment of the upper jaw fitting element, the upper jaw bite fork and/or the at least one jaw relation element may have at least one marking detectable by a detection means, in particular an intraoral scanner. The markings help to digitally allocate the registered or detected positions of the upper jaw and the lower jaw to each other by means of a software program such that the jaw relation position can be correctly constructed by the software program.

The upper jaw fitting element according to the invention can, via the at least one jaw relation element, be connected to an externally controllable motor, which is in turn, either directly or via at least one connecting element, for example a jaw relation element, connected to a lower jaw fitting element, such as a lower jaw paraocclusal bite fork, a lower jaw impression tray, or a lower jaw bite fork, which may be formed analogously to the upper jaw bite fork according to the invention. The externally controllable motor is used for setting the jaw relation position (in a motor-driven manner) and is thus a means for setting the jaw relation position that is motor-controlled instead of manually set.

### BRIEF DESCRIPTION OF THE DRAWINGS

The invention is described in more detail below with reference to the drawings. The drawings are to be understood as merely exemplary. They are schematic, not drawn to scale, and each only show the features essential for understanding the present invention. It will be appreciated that there may be further features, as familiar to a person skilled in the art. In the drawings, the same reference numerals designate the same or corresponding elements. In the drawings:

FIG. 1 shows a plan view of an upper jaw fitting element adapted as an upper jaw bite fork with an integrally formed jaw relation element;

FIG. 2 shows an exploded view of the upper jaw fitting element according to the invention in a first exemplary embodiment adapted as an upper jaw bite fork with a separately formed jaw relation element and further jaw relation elements for setting a jaw relation;

FIG. 3 shows a side view of a human skull with the lower jaw in the habitual lower jaw opening position and with the upper jaw fitting element according to the invention in the first embodiment and the jaw relation elements of FIG. 2;

FIG. 4 shows an exploded view of one possible embodiment of the upper jaw fitting element according to the invention with an alternatively formed upper jaw bite fork and the jaw relation elements for setting a jaw relation of FIG. 2;

FIG. 5 shows an exploded view of one exemplary embodiment of the upper jaw fitting element according to the invention with a separately formed jaw relation element;

FIG. 6 shows the upper jaw fitting element of FIG. 5, additionally with a buccally arranged jaw relation element;

FIG. 7 shows a front view of a human skull with the lower jaw in the habitual lower jaw opening position and with the upper jaw fitting element according to the invention in one possible embodiment with buccal jaw relation elements attached thereto on both sides and openings in the anterior tooth area for filling in impression material;

FIG. 8 shows a perspective view of an exemplary embodiment of means for setting a jaw relation of a patient;

FIG. 9 shows a perspective view of an exemplary embodiment of means for detecting a jaw relation of a patient;

FIG. 10 shows a side view of a human skull with the lower jaw in the habitual lower jaw opening position and with the upper jaw fitting element according to the invention, a lower jaw fitting element and another exemplary embodiment of means for setting a jaw relation; and

FIG. 11 shows an illustration of an upper jaw dental arch and a lower jaw dental arch to illustrate the dental scheme.

### DETAILED DESCRIPTION OF THE INVENTION

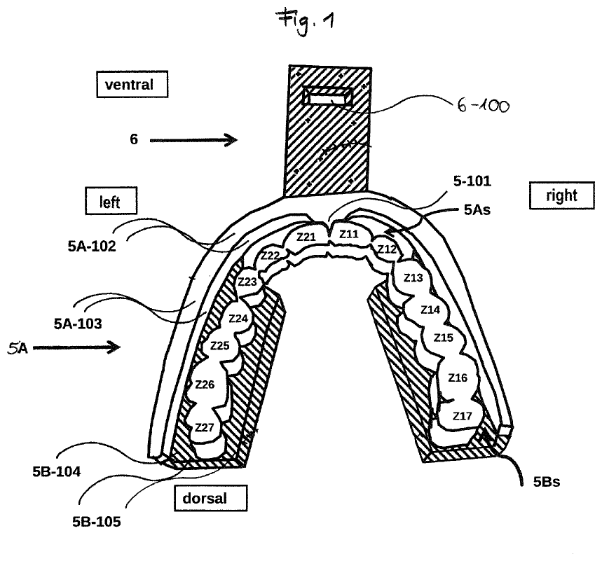

FIG. 1 shows a plan view of an upper jaw fitting element according to the invention adapted as an upper jaw bite fork 5. In the first exemplary embodiment shown in FIG. 1, the upper jaw bite fork 5 is integrally formed with a first jaw relation element 6.

The upper jaw bite fork 5 of FIG. 1 comprises a dental arc-shaped section 5A having an anterior portion 5A-102 and a posterior portion 5A-103 and two receiving areas 5B arranged at dorsally arranged open end sections of the upper jaw bite fork 5. The receiving areas 5B have a substantially L-shaped cross-section having a first portion 5B-104 arranged buccally to the tooth crowns (see FIG. 11) of an upper jaw 3, and a second portion 5B-105 arranged caudally to the tooth crowns of the upper jaw 3. In this first embodiment, the receiving areas 5B extend substantially in the area of the canine teeth Z23, Z13 and the posterior teeth, i.e., the molars and premolars, Z24 to Z27 and Z14 to Z17, respectively, leaving out an area 9 of the anterior teeth Z12 to Z22, which may also be referred to as incisors Z12 to Z22.

In the area of the anterior teeth Z12 to Z22, the anterior portion 5A-102 of the upper jaw bite fork 5 extends, separated from the tooth crowns Z12 to Z22 by a gap 5As, also referred to as intermediate space 5As, labially to these tooth crowns and above, i.e., cranially to, their incisal edges in the upper jaw 3. The width of the intermediate space 5As is here predetermined by a spacer 5-101 in the area of the teeth Z11 and Z21 of the upper jaw 3. The spacer 5-101, which may also be referred to as an interdental pin 5-101, is formed on the inner side of the anterior portion 5A-102, i.e., the side facing the tooth crowns Z11, Z21, as an extension in the dorsal direction and with its tip arranged approximally or, if applicable, interdentally between Z11 and Z21. In addition, it serves for the, preferably central, alignment of the upper jaw bite fork 5 on the upper jaw 3.

The interdental pin 5-101 thus prevents the upper jaw bite fork 5 from tilting and at the same time defines the width of the intermediate space 5As. The anterior portion 5A-102 in the area of the anterior teeth merges, in the canine and posterior teeth area Z13 to Z17 and Z23 to Z27 in the upper jaw 3 (with its gap 5As), rearward, i.e., dorsally, into the posterior portion 5A-103 and extends here labially or buccally and spaced apart, by a gap or intermediate space 5Bs, from the tooth crown surfaces. The posterior portion 5A-103 merges into the downward, i.e., caudally, extending receiving area portion 5B-104, which in turn merges into the horizontally extending portion 5B-105 to rest on, against or close to the occlusal surfaces of these teeth. The width and length of the upper jaw bite fork 5 are ready-made such that it can be used with no or only minor adjustments for the widths and lengths of the dental arch of each subject or patient and can thus be used for all internationally known standard sizes for impression trays.

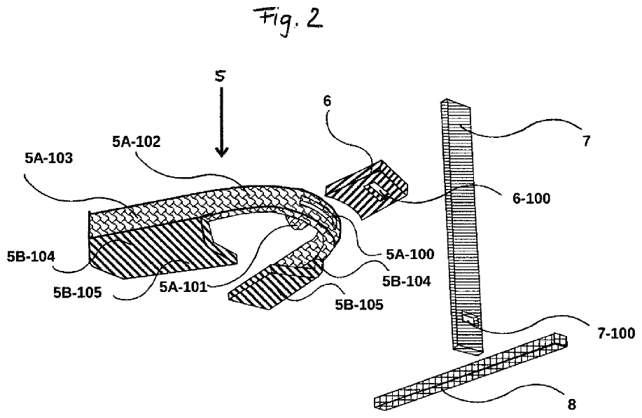

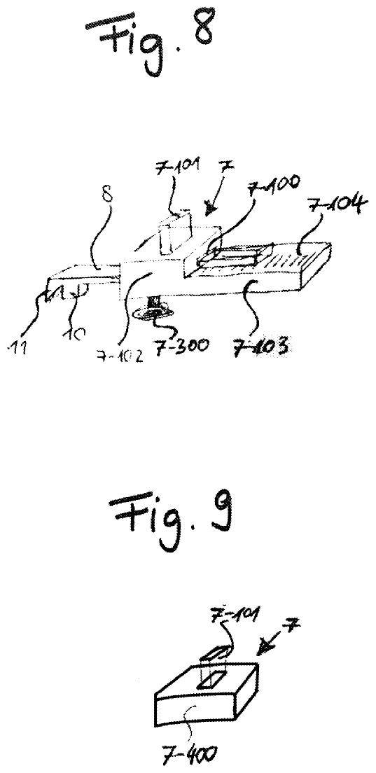

In the area of a front, central vertex of the arch of the upper jaw bite fork 5, a first jaw relation element 6, integrally formed with the upper jaw bite fork 5, is arranged. A cut-out 6-100, which serves to receive another jaw relation element, is formed within the jaw relation element 6 (see FIG. 2, FIG. 8 or FIG. 9).

The upper jaw bite fork portion 5A is guided into the vestibule, i.e., the oral cavity, to such an extent that the upper jaw bite fork 5 is sufficiently fixed by bearing, with impression material in between, on the teeth, or on the teeth and the gingiva of the alveolar process, or these and the vestibule, in particular in the area of the receiving areas 5B.

FIG. 2 shows an exploded view of the upper jaw bite fork 5 and the first jaw relation element 6, which substantially correspond to the first embodiment of FIG. 1 but have the first jaw relation element 6 formed separately from the upper jaw bite fork 5. Furthermore, FIG. 2 shows further jaw relation elements 7, 8, which together form means for adjusting a patient's jaw relation.

The first jaw relation element 6 can be reversibly fixed in a cut-out 5A-100 formed in the upper jaw bite fork 5 by a positive clamping fit. This makes it possible to use an upper jaw bite fork 5 individually adapted to the patient together with a standardized jaw relation element 6. A second jaw relation element 7 is connected to the jaw relation element 6 by means of a cut-out 6-100, and a third jaw relation element 8 is connected to the second jaw relation element 7 by means of a cut-out 7-100. The cut-outs 6-100, 7-100 and the jaw relation elements 7, 8 are formed such that a sufficiently firm connection is formed between the elements 6, 7, 8, however, yet allowing for a displacement in terms of an adjustment in relation to each other for the alignment to the respective jaw relation. Instead of such positive clamping fits, guided fits with locking screws (not shown) and, instead of displacement, gear guidance via knurls (the latter not shown) may also be used, provided that they meet the requirements for an adjustment. It is also conceivable to make the jaw relation elements 6, 7, 8 and the associated cut-outs 6-100, 7-100 cylindrical, i.e., with a round cross-section, in order to be able to, in addition to the relative axial displacement, also rotate them in relation to each other. Furthermore, it is conceivable to connect the jaw relation elements 6, 7, 8 to each other by means of articulated joints, or to provide articulated joints within the jaw relation elements 6, 7, 8, to be able to realize further moving and setting options.

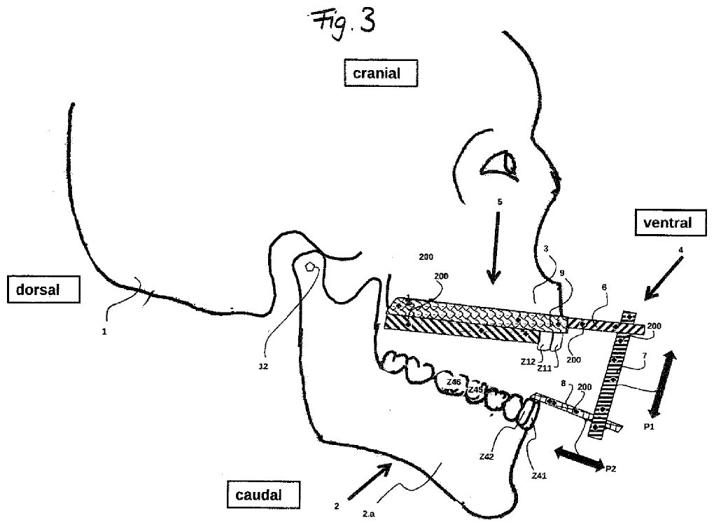

FIG. 3 shows the first embodiment of the upper jaw fitting element shown in FIG. 2 with the jaw relation elements 6, 7, 8 for setting a jaw relation in a side view when inserted into the mouth of a patient. FIG. 3 schematically shows a human skull 1 in a side view, with a lower jaw 2 in a predetermined habitual lower jaw opening position 2.a in relation to the upper jaw 3. The upper jaw fitting element, adapted as the upper jaw bite fork 5 in the first embodiment of FIG. 2, is arranged on the upper jaw 3. The upper jaw bite fork 5 comprises the first jaw relation element 6, which is formed extending forward, i.e., extending ventrally, as a jaw relation element formed separately from the upper jaw bite fork 5. The second jaw relation element 7, which is formed extending downward, i.e., extending caudally, from the first jaw relation element 6; and the third jaw relation element 8, which is formed extending rearward, i.e., extending dorsally, from the second jaw relation element 7. The jaw relation elements 6, 7, 8 formed separately from the upper jaw bite fork 5 may also be collectively referred to as device 4, which is a means for setting a jaw relation position.

Together with the upper jaw bite fork 5, the device 4 provides a static lower jaw opening position in the habitual lower jaw opening position 2.a selected as an example, i.e., a support of the lower jaw 2 with respect to the upper jaw 3 (passive method) as an aid to help a human subject hold this lower jaw opening position 2.a. This is possible because the individual elements of the device 4 extending forward from the upper jaw bite fork 5 can be movably adjusted and locked in relation to one another. In the exemplary embodiment shown here, the second jaw relation element 7 is, by way of example, in its direction of extension, movably connected to the first jaw relation element 6 (see arrow P1) and arranged transversely to the first jaw relation element 6, and the third jaw relation element 8 is, in its direction of extension, movably connected to the second jaw relation element 7 (see arrow P2) and arranged transversely to the second jaw relation element 7. Furthermore, the third jaw relation element 8 rests on the incisal edge, i.e., the cutting edge, of one or more of the first lower incisors Z32 to Z42 (see FIG. 11).

The cut-outs in the area 9 of in the upper incisors Z12 to Z21, or in the area of the upper incisors and canine teeth Z13 to Z23, can reduce a bite lock caused by the upper jaw bite fork 5, as described above. If the teeth Z12 to Z21 or Z13 to Z23, which are the longest, were also covered by the upper jaw bite fork 5, the bite lock would be larger and reduce the variations of the jaw relations adjustable by the device.

Therefore, the device 4 is, among other things, particularly suitable for use in the registration of a particular active lower jaw protrusion for manufacturing mandibular advancement splints (UPS) for the treatment of snoring or nocturnal obstructive respiratory disorders. The UPS are splint systems that rest against the upper jaw tooth crowns and lower jaw tooth crowns, thereby causing an equal or larger bite lock, even when the anterior tooth crowns or the anterior and canine tooth crowns are left out, than when inserting the device 4 with the upper jaw bite fork 5. The device 4 in combination with the upper jaw bite fork 5 may hereinafter also be referred to as means 45. This difference in bite lock between using a UPS and using means 5 leaves at least one such gap between the upper jaw incisal edges and lower jaw incisal edges free for the device 4, through which the third jaw relation element 8 can rest on the incisal edges of the lower incisors Z32 to Z42 and bring the lower jaw 2 into position.

In addition, the device 4 is, among other things, particularly suitable for use in the manufacture of splints that rest on the upper jaw or the lower jaw in all crown areas, i.e., including all anterior tooth crowns of the corresponding jaw. Such splints are used, for example, in the therapy for temporomandibular joints, jaw musculature, tooth misalignments and jaw fractures.

Markings 200, e.g., optical markers, (shown as crosses) arranged on the surfaces of the upper jaw bite fork 5 and the device 4 serve to render scanning methods, e.g., by means of optical intraoral scanners, more accurate and/or serve as an electronic measuring system formed as a transmitter/receiver system 200 for metrological determination of the jaw relation, which will be discussed later.

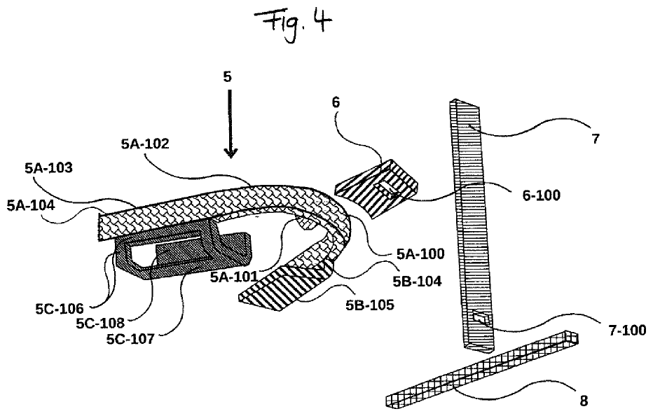

FIG. 4 shows another possible design of the receiving areas 5B, which is substantially composed of a modification of the portions 5B-104 and 5B-105 of FIG. 2 and comprises further cut-outs in the tooth crown area as well as an additional portion arranged palatally to the tooth crowns.

The upper jaw fitting element shown in FIG. 4 substantially corresponds to the embodiment shown in FIG. 2 and differs from FIG. 2 only in that the (from the patient's perspective) right receiving area is formed according to a second embodiment. To illustrate the differences, the (from the patient's perspective) left receiving area is shown according to the first embodiment (see FIG. 2). In practical use, the receiving areas on the upper jaw bite fork 5 are preferably formed according to the same embodiment on both sides.

The portions 5B-104 and 5B-105 of the receiving area 5B according to the first exemplary embodiment have, according to the second embodiment, a buccally arranged window-like cut-out and are designated by reference signs 5C-106 and 5C-107. Further, the horizontal portion 5C-107 according to the second embodiment is continued by a portion 5C-108 to increase the retention along the palatal crown side of the tooth crowns. Further, the receiving area 5C according to the second embodiment is distally shortened compared to the receiving area 5B according to the first embodiment and does not extend all the way to the end of the tooth row Z17, Z27. The dental arch-shaped portion 5A of the upper jaw bite fork 5 is unaltered compared to the first embodiment, such that a portion 5A-104 of the portion 5A projects distally beyond the distal end of the receiving areas 5C according to the second embodiment. A portion of the lateral and caudal surfaces of the tooth crowns is partially exposed by the cut-out in areas of portions 5C-106 and 5C-107, thereby, in addition to scanning the cut-out tooth crown portions of the anterior teeth or the anterior and canine teeth, also allowing for scanning these lateral and rear cut-out tooth crown portions when the upper jaw bite fork (5) is inserted. This means that the portion 5C-107 of the second embodiment is, in the buccal direction, narrower in the area of the cut-out than the portion 5B-105 of the first embodiment. This enhances the superimposition of different scans. This also improves the scanning accuracy.

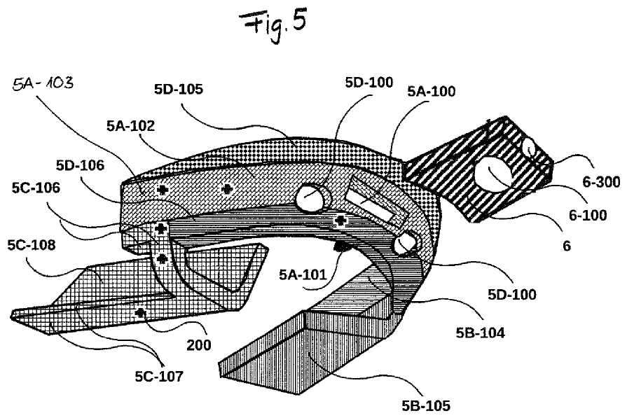

FIG. 5 shows a third exemplary embodiment of the upper jaw fitting element adapted as the upper jaw bite fork 5. Compared to the first and second embodiments of FIGS. 1 to 4, the dental arch-shaped section 5A of the upper jaw bite fork 5 is shortened by having the posterior portion 5A-103 distally significantly shortened. The anterior portion 5A-102 is, compared to the previous embodiments, extended both cranially and caudally. To illustrate the difference to the previous embodiments of the upper jaw bite fork 5, a cranial extension 5D-105 and a caudal extension 5D-106 are shown distinct from the anterior portion 5A-103 of the upper jaw bite fork 5. In practice, the upper jaw bite fork comprising the portion 5A-102 and the extensions 5D-105 and 5D-106 is formed in one piece, i.e., integrally. In the embodiment shown here, the cranial extension 5D-105 additionally tapers in the dorsal direction, i.e., backwards, towards the open end sections of the upper jaw bite fork 5. It is also conceivable that the caudal extension 5D-106 is caudally widened towards the receiving areas, and in particular merges, flush with the portion 5C-106, into the portion 5C-107 of the receiving area.

In the area 9 of the anterior tooth crowns, openings 5D-100 for receiving the first jaw relation element 6 are formed on both sides of the cut-out 5A-100. The openings 5D-100 serve to fill the intermediate space 5As between the labial tooth crown surfaces of the incisors Z12 to Z22 and, if applicable, other teeth such as the canine teeth Z13, Z23, the gingiva adjacent thereto and, if applicable, at least portions of the vestibule and the upper jaw bite fork 5, with impression material after the upper jaw bite fork 5 has been aligned to and positioned on the upper jaw 3.

To align or position the upper jaw bite fork 5 to/on the upper jaw 3, impression material is first applied to the surfaces of the portions 5C-107 or 5C-108 of the receiving areas facing the tooth crowns, and the upper jaw bite fork 5 is then “roughly”, with the impression material in between, fitted to the teeth in the area of the receiving areas. It is then advantageous if the patient bites down so that the upper jaw bite fork 5 is securely “clamped” between the upper and lower tooth rows and thus fixed in position while the impression material hardens. After the impression material has hardened, the gap 5As, and optionally also the gap 5Bs and/or other adjacent gaps, are filled with impression material from the outside via the openings 5D-100. After this impression material has also hardened, the upper jaw bite fork 5 is sufficiently stably fixed to the upper jaw tooth crowns and the upper jaw alveolar process to reliably prevent it from unintentionally tilting and/or slipping and/or coming off.

In particular for filling the gap 5Bs and, if applicable, other adjacent gaps, with impression material from the outside, the openings 5D-100 may also be formed closer to the open end sections in the upper jaw bite fork 5, or, as shown in FIG. 5, in addition to the openings 5D-100, further openings 5D-100 may be provided in the posterior tooth area of the upper jaw bite fork 5.

The cranial and caudal extension 5D-105, 5D-106, in particular of the portion 5A-102, of the upper jaw bite fork 5, increases the contact surface of the upper jaw bite fork 5 according to the previous embodiments such that the upper jaw bite fork 5, with the impression material, filled into the intermediate space 5As from the outside, in between, not only adheres to the upper jaw tooth crowns and parts of the adjacent gingiva but extends beyond the gingiva to the alveolar process in the vestibule. Furthermore, by introducing the impression material subsequently, preferably under pressure, into the intermediate space 5As by filling it in from the outside, it is possible for the impression material to also reach interdental spaces and other void spaces of the vestibule that are difficult to access.

The distally shortened upper jaw bite fork 5 thus extends less far in the dorsal direction, i.e., rearwards, compared to the previous embodiments, and at least no longer extends over the molars, but ends in the area of the premolars or in the area of the canine teeth. Due to the extensions 5D-105, 5D-106 in the anterior tooth area and to filling the intermediate space 5As as described, the upper jaw bite fork 5 is, despite being shortened, fixed in a sufficiently stable manner to be able to move the jaw relation elements 6, 7, 8 attached to the upper jaw bite fork 5 for setting a jaw relation without the upper jaw bite fork 5 slipping or tilting on the tooth crowns of the upper jaw 3.

By shortening the upper jaw bite fork 5 (by the posterior portion 5A-103) and optionally tapering the cranial extension 5D-105, the wearing comfort for the patient is improved, since the space available in the distal upper jaw area gradually decreases from ventral to dorsal and is not completely filled by the upper jaw bite fork 5 having this design. This serves in particular to prevent the patient from gagging.

In addition, the embodiment of the upper jaw bite fork 5 shown in FIG. 5 differs in the design of the receiving areas. As already shown in FIG. 4, to illustrate the differences compared to the receiving areas 5B of the first embodiment, the (from the patient's perspective) left receiving area in FIG. 5 is formed according to the first embodiment (see FIG. 2). The (from the patient's perspective) right receiving area in FIG. 5 is formed according to a third embodiment. As already explained in connection with FIG. 4, in practice, the upper jaw bite fork 5 comprises receiving areas that are preferably formed identically on both sides.

The receiving area according to the third embodiment substantially corresponds to the receiving area according to the second embodiment (see FIG. 4). The receiving area according to the third embodiment differs from the receiving area according to the second embodiment in that the portion 5C-106 is distally shortened and now only forms a pin-like fastening section which is connected to the portion 5A-103 and/or the extension 5D-106 of the upper jaw bite fork 5. Due to the distally shortened portion 5C-106, the distal connecting section between portions 5C-106 and 5C-107 according to the second embodiment, quasi the distally arranged fastening pin-like portion 5C-106 in FIG. 4, is omitted in the third embodiment, so that the end of the portion 5C-107 of the third embodiment is distally narrowed down to the width in the area of the cut-out according to the second embodiment.

Thus, not only parts of the occlusal and buccal surfaces of tooth crown portions remain free in the cut-outs of 5C-106 and 5C-107, as shown in FIG. 4, but additional occlusal and buccal tooth crown portions are also exposed through a distal, dorsally open cut-out, as shown in FIG. 5, and can thereby be detected by a detection means.

The receiving area in the third embodiment thus comprises a substantially L-shaped cross-section formed by the horizontal portion 5C-107 and the vertical portion 5C-108, both extending in the ventral-dorsal direction along the row of teeth. The horizontal portion 5C-107 is caudally applied to, in contact with and/or spaced apart from, the occlusal surfaces of the upper jaw tooth crowns, and the vertical portion 5C-108 extends from the horizontal portion 5C-107 in the cranial direction and palatally to, in contact with and/or spaced apart from, the tooth crowns. The receiving area according to the third embodiment is connected to the dental arch-shaped portion 5A of the upper jaw bite fork 5 via the fastening section 5C-106, as already described.

The fastening section 5C-106 is, in the cranial direction, formed in a pin-like manner on the distally strongly shortened element 5A-103 of the bite fork 5, so that, compared to the first embodiment and in particular to the second embodiment, a large part of the dorsally extending receiving area comprises no further contact points or fastening points on the portion 5A of the upper jaw bite fork 5. Due to the L-shaped configuration of the receiving areas 5C-107 and 5C-108, the fit of the upper jaw fitting element is secured against horizontal movements. Furthermore, it is conceivable to additionally stabilize the fastening section 5C-106 against mechanical stress by caudally widening the distal area of the portion 5D-106 to an extent that it contacts the portion 5C-107 and thus improves the connection of the receiving areas to the upper jaw bite fork portion 5A in terms of stability and/or rigidity and/or strength.

Compared to the first, but also to the second embodiment, the third embodiment has thus greatly reduced the distal receiving areas and greatly extended the ventral receiving areas. In the distal receiving areas, this leads to an increased number of exposed crown areas, gingival areas and vestibular areas, which facilitates analog and digital registration and increases the wearing comfort for the patient. In the ventral areas, this leads to an improved retention of the upper jaw fitting element on the teeth and the alveolar process and vestibule and thus on the upper jaw 3.

In addition, FIG. 5 shows another possible embodiment of the first jaw relation element 6. The jaw relation element 6 according to this embodiment comprises a round cut-out 6-100 for receiving another jaw relation element 7. The second jaw relation element 7, which comprises a mirror-inverted cylindrically formed connecting element, can thus be rotated in relation to the first jaw relation element 6, thus increasing the setting options for setting a jaw relation position by means of the jaw relation elements. In addition, the first jaw relation element 6 comprises a through-hole 6-300 arranged at an angle with respect to the cut-out 6-100 and extending into the cut-out 6-100. The through-hole 6-300 preferably comprises a thread and serves to receive a locking bolt or a locking screw, by means of which the jaw relation element 7 is fixed or secured in the cut-out 6-100.

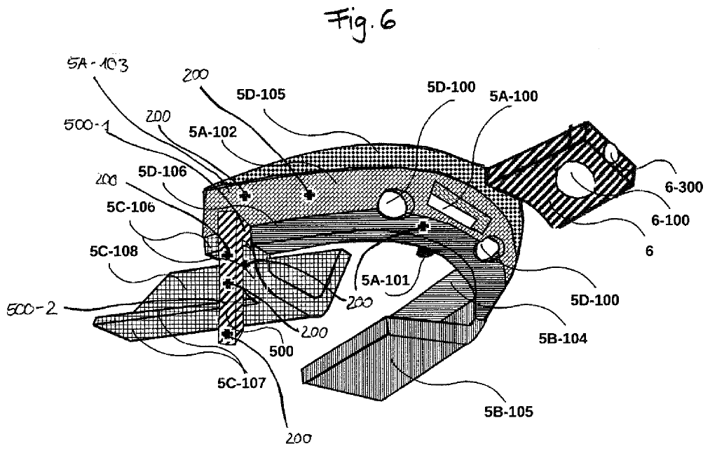

FIG. 6 corresponds predominantly to the embodiment of the upper jaw fitting element shown in FIG. 5, but in FIG. 6, an additional jaw relation element 500 is provided. This comprises a substantially horizontal portion 500-1 and a substantially vertical portion 500-2, with the portion 500-1 spacing the portion 500-2 apart from the upper jaw bite fork 5 in the labial direction.

The jaw relation element 500 comprises several markings 200 that can be detected by a scanner. Such markings 200 are also arranged in the area of portion 5A. One marking 200 arranged or formed on the jaw relation element 500 is sufficient for detecting a jaw relation element 500 by a detection means, in particular by a scanner. Multiple markings 200 may increase the scanning accuracy.

The jaw relation element 500 serves as an aid for detecting the lower teeth in relation to the upper teeth when the lower teeth are detected by the detection means, for example a scanner, along the exposed upper tooth portions along the upper jaw bite fork 5 via the jaw relation element 500.

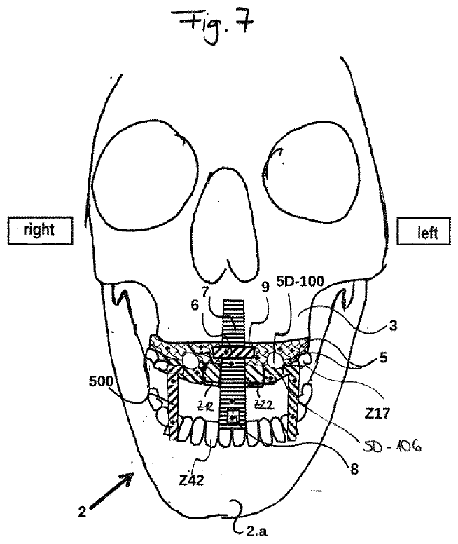

As can be seen in FIG. 7, when the upper jaw bite fork 5 is inserted, the jaw relation elements 500 rest against and/or on and/or close to, and/or are spaced apart from, the lower teeth so that the lower teeth are free to move in all directions in relation to the jaw relation elements 500. With increasing opening of the mouth, the position of the upper jaw bite fork 5 can, due to the limited detection range of the detection unit, in particular an intraoral scanner, no longer be detected together with the upper teeth and the lower teeth in one scan pass. Thus, the upper jaw bite fork 5 and the upper teeth are first scanned together with the jaw relation element 500. In a second scan pass, the lower teeth are then detected together with the jaw relation element 500. In a third step, these two scans are superimposed so that the correct jaw relation position can be determined using the jaw relation elements 500. The jaw relation can also be detected in one continuous scan pass, without superimposing the scan data, by detecting the upper teeth and the upper jaw bite fork 5 together with the jaw relation elements 500 and then during the same scan pass, detecting the lower teeth together with the jaw relation elements 500.

FIG. 8 shows another exemplary embodiment of means 4 for setting a jaw relation position. Here, a peg 7-101 of the jaw relation element 7 is inserted into the cut-out 6-100 of the jaw relation element 6 according to the embodiment shown in FIG. 2 and FIG. 4 and is fixed by means of a positive clamping fit. Alternatively, the peg 7-101 may also have a cylindrical shape and be inserted into the cut-out 6-100 of the jaw relation element 6 according to the embodiment shown in FIG. 5 and FIG. 6 and be fixed thereto. The cylindrical shape of the peg 7-101 allows for additional rotation with respect to the jaw relation element 6, which is not possible with the peg 7-101 as shown in FIG. 8.

The jaw relation member 7 is formed in a step-like manner and comprises a portion 7-102 that is higher than a second portion 7-103. The jaw relation member 8 is movably received in a cut-out 7-100 of the jaw relation member 7, which is formed as a through-hole in the portion 7-102, and is in the portion 7-102 fixed in a position relative to the jaw relation member 7 by a locking screw 7-300. The cut-out 7-100 is formed such that the jaw relation element 8, when inserted into and protruding through the cut-out 7-100, slides on, or is arranged spaced apart from, an upper surface of the portion 7-103. Thus, the jaw relation element 8 is positioned relative to the jaw relation element 7 such as to set the correct horizontal jaw relation position or jaw protrusion relation.

Optionally, a scale 7-104, for example in millimeter steps, may be provided on the portion 7-103 of the jaw relation element 7 the jaw relation element 8 slides on. The scale thus allows for a horizontal orientation, which the initial and final positions of the protrusion settings can be compared to.

FIG. 9 shows another embodiment of a jaw relation element 7, which is adapted as a means for detecting jaw relation data, for example in the form of a scanner. The jaw relation element 7 comprises a detection element or registration unit 7-400, which can be inserted into the cut-out 6-100 of the jaw relation element 6 according to the embodiment shown in FIG. 2 and FIG. 4 via a peg 7-101 by means of a clamping fit. Here, too, as already described in connection with FIG. 8, it is possible to make the peg 7-101 cylindrical and to insert it into the cut-out 6-100 of the jaw relation element 6 according to the embodiment shown in FIG. 5 and FIG. 6 and to fix it with a locking screw.

The detection element 7-400 registers, by means of an optical method or other method, for example with high frequency, laser or ultrasound, the position of at least the lower teeth or portions thereof for determining the jaw relation position between the upper jaw 3 and the lower jaw 2.

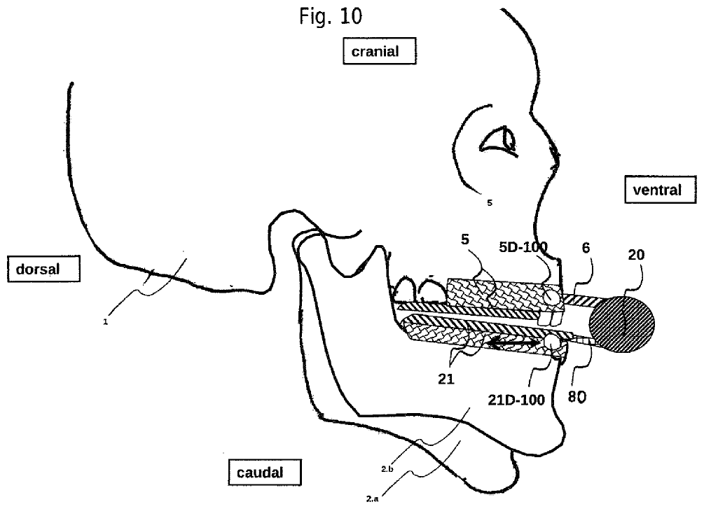

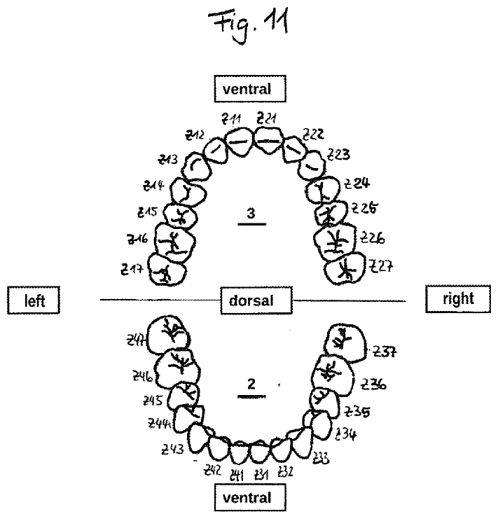

FIG. 10 shows an exemplary application for the upper jaw bite fork 5 according to the invention. Here, the upper jaw bite fork 5 is, via the first jaw relation element 6, connected to a motor 20. Furthermore, a lower jaw bite fork 21, for example a paraocclusional bite fork, is also connected to the motor 20 via a jaw relation element 80. The motor 20 is externally controllable and serves to set the jaw relation position—in the example shown here, a lower jaw protrusion position 2.b of the lower jaw 2. Thus, the motor 20 can be regarded as a means for setting the jaw relation position which allows for a motor-controlled, automatable setting of the jaw relation position.

1. An upper jaw fitting element for fitting to a human upper jaw, which is adapted as an upper jaw bite fork that is dental arch-shaped, which comprises, at least at open end sections, receiving areas configured to reversibly receive, with aid of impression material, upper jaw tooth crowns in a manner as to be stable during manipulation, and which can be connected to at least one jaw relation element in an area of a vertex of the arch, wherein the upper jaw bite fork comprises at least one opening for filling at least one intermediate space in the area of anterior tooth crowns and/or an intermediate space distal to the anterior tooth crowns between the upper jaw bite fork and an upper jaw.

2. The upper jaw fitting element according to claim 1, wherein the receiving areas leave out an area of the anterior tooth crowns and/or anterior tooth crown portions.

3. The upper jaw fitting element according to claim 1, wherein the receiving areas leave out tooth crowns and/or tooth crown portions arranged distally to an area of the anterior tooth crowns.

4. The upper jaw fitting element according to claim 1, wherein the receiving areas comprise a portion arranged palatally adjacent and/or close to or spaced apart from the tooth crowns.

5. The upper jaw fitting element according to claim 1, wherein the upper jaw bite fork is formed at least in the area of the anterior tooth crowns such that gingiva, at least partially vestibule and at least partially labial tooth crown surfaces are concealed.

6. (canceled)

7. The upper jaw fitting element according to claim 1, wherein the upper jaw bite fork is connected with the at least one jaw relation element and/or the upper jaw bite fork and the at least one jaw relation element are integrally formed.

8. The upper jaw fitting element according to claim 1, wherein the at least one jaw relation element is a means for setting a jaw relation and/or a jaw relation movement of a patient.

9. The upper jaw fitting element according to claim 1, wherein the at least one jaw relation element is a means for detecting a jaw relation and/or a jaw relation movement of a patient.

10. The upper jaw fitting element according to claim 1, wherein the open end sections of the upper jaw bite fork and the receiving areas are formed distally flush with each other.

11. The upper jaw fitting element according to claim 1, wherein the open end sections of the upper jaw bite fork and the receiving areas are not formed distally flush with each other.

12. The upper jaw fitting element according to claim 1, wherein the upper jaw bite fork is, in the area of the anterior tooth crowns, in a cranial-caudal direction wider than at the open end sections and tapers along a cranially located upper side.

13. The upper jaw fitting element according to claim 1, wherein the upper jaw bite fork comprises at least one cut-out for receiving the at least one jaw relation element.

14. The upper jaw fitting element according to claim 1, wherein the upper jaw bite fork comprises at least one spacer, in particular an interdental pin, arranged on a surface facing the tooth crowns, which spacer is adapted for aligning the upper jaw bite fork such that between the anterior tooth crowns of the upper jaw and the upper jaw bite fork at least the intermediate space is formed.

15. The upper jaw fitting element according to claim 1, wherein the at least one jaw relation element is arranged buccally on both sides of the upper jaw bite fork.

16. The upper jaw fitting element according to claim 1, wherein the upper jaw bite fork and/or the at least one jaw relation element comprises at least one marking which can be detected by a detection means, in particular an intraoral scanner.
